(19) United States
(12) Patent Application Publication
(10) Pub. No.: US 2026/0023003 A1
(43) Pub. Date: Jan. 22, 2026

(54) AN APPARATUS ARRANGED FOR MEASURING A RHEOLOGICAL PROPERTY AND A METHOD FOR MEASURING A RHEOLOGICAL PROPERTY AND/OR AN INTERFACIAL PROPERTY

(71) Applicant: TECHNISCHE UNIVERSITEIT EINDHOVEN, Eindhoven (NL)

(72) Inventors: Coen Rinus Carel VAN DER GRACHT, Eindhoven (NL); Ruth Maria CARDINAELS, Eindhoven (NL); Nick Olov JAENSSON, Eindhoven (NL)

(21) Appl. No.: 18/875,745

(22) PCT Filed: Apr. 14, 2023
(86) PCT No.: PCT/NL2023/050197

§ 371 Date: Dec. 17, 2024

(30) Foreign Application Priority Data
Jun. 20, 2022 (NL) 2032223

(51) Int. Cl. G01N 11/00; G01N 13/02

(52) U.S. Cl. CPC G01N 11/00; G01N 13/02; G01N 2011/0033; G01N 2011/006; G01N 2013/0283

(57) ABSTRACT

An apparatus and a method arranged for measuring a rheological and/or interfacial property comprising: —a pressure unit arranged for providing a quantity of a gas at a predetermined pressure to a surface of the fluid; —a detection unit arranged for detecting a surface deformation of the fluid, due to the pressurized gas at a plurality of locations at the surface of the fluid; —a reference register comprising reference data related to surface deformations of respective fluids, and related to known rheological and/or interfacial properties of the respective fluids; —a determining unit arranged for: —receiving the detected surface deformation from the detection unit; —accessing the reference data of the reference register; —determining respective correlations between the detected surface deformation, and the surface deformations of the respective fluids from the accessed reference data; and —identifying a fluid of the respective fluids of the reference data based on a maximum correlation among the determined respective correlations; and —an output unit arranged for outputting the rheological and/or interfacial property respectively corresponding with the fluid identified by the determining unit. A method for measuring a rheological and/or interfacial property of a fluid.

According to a first aspect, the present disclosure relates to an apparatus arranged for measuring a rheological property such as viscosity and/or an interfacial property such as surface tension of a fluid such as a liquid, suspension, gel or slurry.

According to a second aspect, the present disclosure relates to a method for measuring a rheological property such as viscosity and/or an interfacial property such as surface tension of a fluid such as a liquid, suspension, gel or slurry.

When rheological properties need to be measured a rheometer usually is used. A rheometer is a laboratory device used to measure the way in which a dense fluid (a liquid, suspension or slurry) flows in response to applied forces. It is used for those fluids which cannot be defined by a single value of viscosity and therefore require more parameters to be set and measured than is the case for a viscometer. It measures the rheology of the fluid.

There are two distinctively different types of rheometers known. Rheometers that control the applied shear stress or shear strain are called rotational or shear rheometers, whereas rheometers that apply extensional stress or extensional strain are extensional rheometers. Rotational or shear type rheometers are usually designed as either a native strain-controlled instrument (control and apply a user-defined shear strain which can then measure the resulting shear stress) or a native stress-controlled instrument (control and apply a user-defined shear stress and measure the resulting shear strain).

The disadvantage of a traditional rheometer is that the measurement itself is complex and it takes quite some time and specific knowledge to interpret the results from this machine.

The traditional rheometer also destroys the test sample and cannot be implemented inline. The most common machine used for measuring surface tension is the pendant drop machine. To use this machine also some specific knowledge is needed to perform the experiment and convert the result to the surface tension.

The apparatus at least partly overcomes one of the mentioned disadvantages since the apparatus according to the present disclosure comprises:
a pressure unit arranged for providing a quantity of a gas, preferably air, at a predetermined pressure to a surface of the fluid;
a detection unit arranged for detecting a surface deformation of the fluid, due to the pressurized gas;
a reference register comprising reference data related to surface deformations of respective fluids, preferably due to pressurized gas at the predetermined pressure, and related to known rheological properties and/or interfacial properties of the respective fluids;
a determining unit arranged for:
receiving the detected surface deformation from the detection unit;
accessing the reference data of the reference register;
determining respective correlations between the detected surface deformation, and the surface deformations of the respective fluids from the accessed reference data; and
identifying a fluid of the respective fluids of the reference data based on a maximum correlation among the determined respective correlations; and
an output unit arranged for outputting the rheological and/or the interfacial property respectively corresponding with the fluid identified by the determining unit.

The apparatus according to the present disclosure is arranged to exert an air puff onto the surface of a liquid with unknown material properties. The surface of this liquid will deform due to the exerted pressure. This deformation of the surface will be monitored over time and compared with numerical simulations that mimic the same deformation. When this simulation and measurements of the deformed surface match, a good estimation of the material properties can be made.

Preferably, the detection unit is arranged for detecting a surface deformation of the fluid, due to the pressurized gas, at a plurality of locations at the surface of the fluid.

In this regard, it is beneficial if the detection unit is arranged for detecting a surface deformation of the fluid, due to the pressurized gas, preferably concurrently, at a plurality of locations at the surface of the fluid.

Preferably, the detection unit is arranged for detecting a surface profile of the fluid.

In an embodiment, the pressure unit is further arranged for providing the quantity of gas at a predetermined flow rate. This is beneficial for realizing a relative accurate measurement of the rheological property and/or the interfacial property.

In another embodiment, the pressure unit comprises a nozzle for providing, via a nozzle opening thereof, the quantity of gas to the surface of the fluid, wherein the apparatus further comprises a positioning unit for positioning the nozzle opening relative to the surface of the fluid at a predetermined distance from the surface of the fluid. This is beneficial for realizing a relative accurate measurement of the rheological property and/or the interfacial property.

Preferably, the nozzle opening defines a predetermined area of providing the quantity of gas to the surface of the fluid. This is beneficial for realizing a relative accurate measurement of the rheological property and/or the interfacial property.

In an embodiment, the detection unit comprises a laser sensor, preferably a 2D surface laser sensor, more preferably a 2D triangulation laser sensor. This is beneficial for realizing a relative accurate measurement of the rheological property and/or the interfacial property. Alternatively, or in addition to the laser sensor, the detection unit comprises a sonar unit.

The laser sensor provides a beam of electromagnetic radiation onto the surface of the liquid. The laser sensor further comprises a camera that is directed under an angle at the surface of the fluid. This camera is arranged for receiving electromagnetic radiation originating from the laser sensor that is reflected at the surface of fluid. Due to the deformation, the intensity of the electromagnetic radiation will vary depending on the position of the reflection at the surface.

The determining unit is preferably arranged for determining the surface profile of the fluid based on the position dependent intensity received by the camera.

In another embodiment, the reference data, comprised by the reference register, is at least partly related to surface deformations of respective fluids, detected by the detection unit, and related to rheological and/or interfacial properties of the respective fluids, determined by the determining unit. This is beneficial for realizing a relative accurate measurement of the rheological and/or interfacial property.

In yet another embodiment, the reference data, comprised by the reference register, is at least partly related to computer simulations of surface deformations of respective fluids having known rheological and/or interfacial properties. This is beneficial for realizing a relative accurate measurement of the rheological property and/or the interfacial property.

Preferably, the apparatus comprises a processing unit arranged for performing simulations of surface deformations of respective fluids having known rheological properties and/or interfacial properties.

In this regard, it is beneficial if the determining unit is further arranged for:
determining that respective correlations between the detected surface deformation, and the surface deformations of the respective fluids from the accessed reference data are below a predetermined threshold value;
instructing the processing unit to perform simulations of surface deformations of respective fluids having known rheological and/or interfacial properties for obtaining further reference data related to surface deformations of fluids having rheological and/or interfacial properties that differ from the rheological and/or interfacial properties of the respective fluids of the reference data; and
adding, by the reference register, the further reference data to the reference data of the reference register.

In this regard, it is beneficial if the determining unit is arranged for repeating the steps of:
determining respective correlations between the detected surface deformation, and the surface deformations of the respective fluids from the accessed reference data;
determining that respective correlations between the detected surface deformation, and the surface deformations of the respective fluids from the accessed reference data are below the predetermined threshold value;
instructing the processing unit to perform simulations of surface deformations of respective fluids having known rheological and/or interfacial properties for obtaining further reference data related to surface deformations of fluids having rheological and/or interfacial properties that differ from the rheological and/or interfacial properties of the respective fluids of the reference data; and
adding, by the reference register, the further reference data, received by the reference register from the processing unit, to the reference data of the reference register;
   until a correlation of the respective correlations reaches or exceeds the predetermined threshold value.

Preferably, the maximum correlation is determined using maximum likelihood, least squares method, Bayesian inference.

The apparatus may be arranged for measuring at least one of a viscosity of the fluid, a surface tension of the fluid, a yield stress of the fluid and viscoelasticity properties of the fluid, wherein the reference register comprises reference data related to at least one of a viscosity of the fluid, a surface tension of the fluid, a yield stress of the fluid and viscoelasticity properties of the fluid.

In an embodiment, the detection unit is further arranged for detecting a time dependent surface deformation, due to the pressurized gas. This is beneficial for realizing a relative accurate measurement of the surface tension of the fluid.

Preferably, the reference data, comprised by the reference register, is at least partly related to maximum surface deformations of respective fluids and related to known rheological and/or interfacial properties of the respective fluids and wherein the determining unit is further arranged for:
determining a maximum surface deformation over time of the time dependent surface deformation; and
determining respective correlations between the detected maximum surface deformation, and the maximum surface deformations of the respective fluids from the accessed reference data. This is beneficial for realizing a relative accurate measurement of the viscosity of the fluid.

In another embodiment, the reference data, comprised by the reference register, is at least partly related to time dependent surface deformations of respective fluids and related to known rheological and/or interfacial properties of the respective fluids and wherein the determining unit is further arranged for:
determining a gradient of the time dependent surface deformation; and
determining respective correlations between the gradient of the time dependent surface deformation, and the time dependent surface deformations of the respective fluids from the accessed reference data. This is beneficial for realizing a relative accurate measurement of the viscosity of the fluid.

Preferably, the determining unit is further arranged for receiving, from a sensing unit a temperature, preferably a time-dependent temperature, of the fluid.

Preferably, the determining unit is further arranged for receiving, from a further sensing unit, a time-dependent pressure supplied to the pressure unit.

Preferably, the detection unit arranged for detecting a time-dependent surface deformation of the fluid.

Preferably, the pressure unit is arranged for varying the predetermined pressure, preferably arranged for varying the predetermined pressure in an oscillatory manner. This is beneficial for extracting material parameters for perturbing fluids.

It is advantageous if the apparatus comprises a container, such as a plate, arranged for holding the fluid.

In this regard, it is beneficial if the apparatus is provided with a conditioning arrangement arranged for conditioning a temperature of the container.

Preferably, the conditioning arrangement comprises a heating arrangement for heating the container and/or a cooling arrangement for cooling the container.

It is beneficial if the apparatus further comprises a temperature controller arranged for controlling the conditioning arrangement for heating and/or cooling the container.

Preferably, the temperature controller is further arranged for maintaining a temperature of the container within a predetermined range, preferably for maintaining the temperature of the container constant.

In an embodiment, the container comprises an aluminium cup.

Preferably, the conditioning arrangement is provided with a Peltier element and a copper water cool block attached to the bottom. The Peltier element makes it possible to either cool or heat the container. The copper water cool block is arranged to cool the hot side of the Peltier element if the Peltier element is cooling the sample holder. The water cool block is connected to tubing and a water pump which is in a cold water basin.

According to the second aspect, the present disclosure relates to a method for measuring a rheological property such as viscosity and/or an interfacial property such as surface tension of a fluid such as a liquid, suspension, gel or slurry, the method comprising the steps of:
providing, by a pressure unit, a quantity of a gas, preferably air, at a predetermined pressure to a surface of the fluid;
detecting, by a detection unit, a surface deformation of the fluid, due to the pressurized gas;
providing, a reference register comprising reference data related to surface deformations of respective fluids, preferably due to pressurized gas at the predetermined pressure, and related to known rheological and/or interfacial properties of the respective fluids;
receiving, by a determining unit the detected surface deformation from the detection unit;
accessing, by the determining unit, the reference data of the reference register;
determining, by the determining unit, respective correlations between the detected surface deformation, and the surface deformations of the respective fluids from the accessed reference data;
identifying, by the determining unit, a fluid of the respective fluids of the reference data based on a maximum correlation among the determined respective correlations; and
outputting, by an output unit, the rheological property and/or an interfacial property respectively corresponding with the fluid identified by the determining unit.

Embodiments of the method according to the second aspect correspond to embodiments of the apparatus according to the first aspect of the present disclosure. The advantages of the method according to the second aspect correspond to advantages of the apparatus according to the first aspect of the present disclosure presented previously.

In an embodiment, during the step of providing the quantity of gas, the gas is provided at a predetermined flow rate.

In another embodiment, the reference data, comprised by the reference register, is at least partly related to maximum surface deformations of respective fluids and related to known rheological and/or interfacial properties of the respective fluids and wherein the method further comprises the steps of:
determining, by the determining unit, a maximum surface deformation of a time dependent surface deformation; and
determining, by the determining unit, respective correlations between the detected maximum surface deformation, and the maximum surface deformations of the respective fluids from the accessed reference data.

In yet another embodiment, the reference data, comprised by the reference register, is at least partly related to time dependent surface deformations of respective fluids and related to known rheological and/or interfacial properties of the respective fluids and wherein the method further comprises the steps of:
determining, by the determining unit, a gradient of the time dependent surface deformation; and
determining, by the determining unit, respective correlations between the gradient of the time dependent surface deformation, and the time dependent surface deformations of the respective fluids from the accessed reference data.

Preferably, during the step of detecting, by the detection unit, a surface deformation of the fluid, due to the pressurized gas is detected, preferably concurrently, at a plurality of locations at the surface of the fluid.

Preferably, during the step of detecting, by the detection unit, a surface profile of the fluid is detected.

Preferably, during the step of providing the quantity of gas by the pressure unit, the predetermined pressure is constant.

Preferably, during the step of providing the quantity of gas by the pressure unit, the predetermined pressure is varied, preferably wherein the predetermined pressure is varied in an oscillatory manner.

It is advantageous if the method further comprises the step of providing the fluid in the container.

In an embodiment, the method further comprises the step of conditioning, by the conditioning arrangement, a temperature of the container.

Preferably, during the step of conditioning, the conditioning arrangement is heating and/or cooling the fluid.

It is beneficial if, during the step of conditioning, the temperature controller is controlling the conditioning arrangement for heating and/or cooling the fluid.

Preferably, during the step of conditioning, the temperature controller is maintaining the temperature of the fluid within the predetermined range, preferably is maintaining the temperature of the fluid constant.

Preferably, the method further comprises the steps of:
determining, by the determining unit, that respective correlations between the detected surface deformation, and the surface deformations of the respective fluids from the accessed reference data are below a predetermined threshold value;
performing, by the processing unit, simulations of surface deformations of respective fluids having known rheological and/or interfacial properties for obtaining further reference data related to surface deformations of fluids having rheological and/or interfacial properties that differ from the rheological and/or interfacial properties of the respective fluids of the reference data; and
adding, by the reference register, the further reference data to the reference data of the reference register.

In this regard, it is beneficial if the method comprises repeating the steps of:
determining, by the determining unit, respective correlations between the detected surface deformation, and the surface deformations of the respective fluids from the accessed reference data;
determining, by the determining unit, that respective correlations between the detected surface deformation, and the surface deformations of the respective fluids from the accessed reference data are below the predetermined threshold value;
performing, by the processing unit, simulations of surface deformations of respective fluids having known rheological and/or interfacial properties for obtaining further reference data related to surface deformations of fluids having rheological and/or interfacial properties that differ from the rheological and/or interfacial properties of the respective fluids of the reference data; and
adding, by the reference register, the further reference data, received by the reference register from the processing unit, to the reference data of the reference register;
   until a correlation of the respective correlations reaches or exceeds the predetermined threshold value.

The apparatus and the methods according to the present disclosure will next be explained by means of the accompanying schematic figures. In the figures:

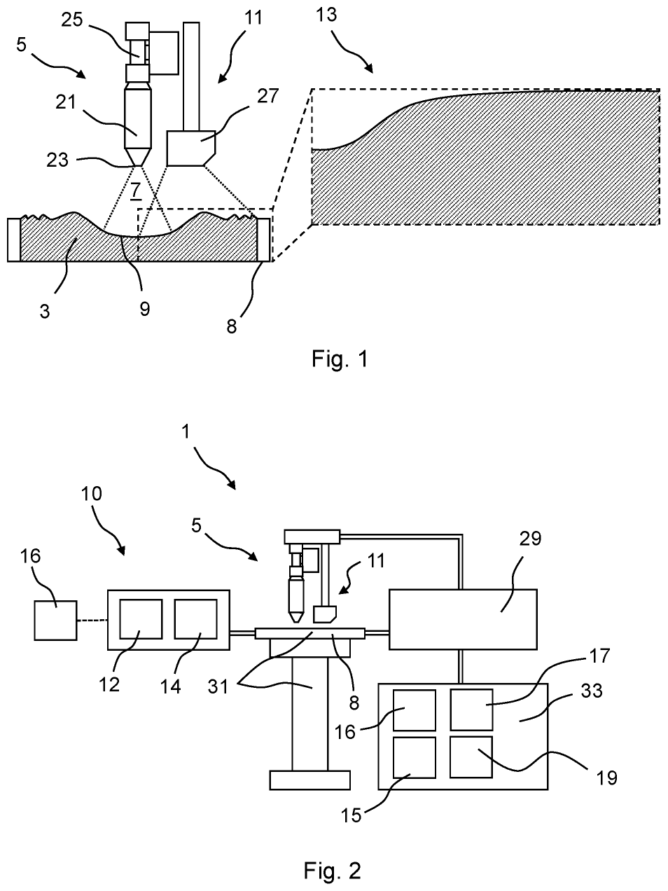

FIG. 1: a distortion of a surface of a fluid is shown;

FIG. 1A: illustrates a simulation domain that may be used for a simulation in an exemplary embodiment of the present disclosure;

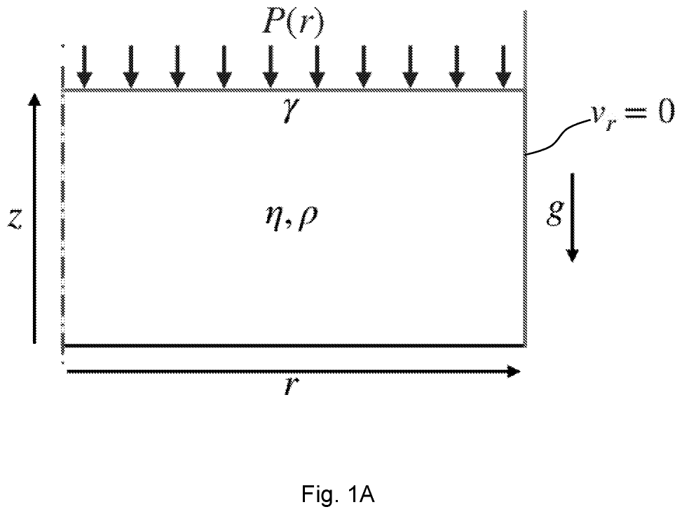

FIG. 2: an apparatus according to the first aspect of the present disclosure is shown;

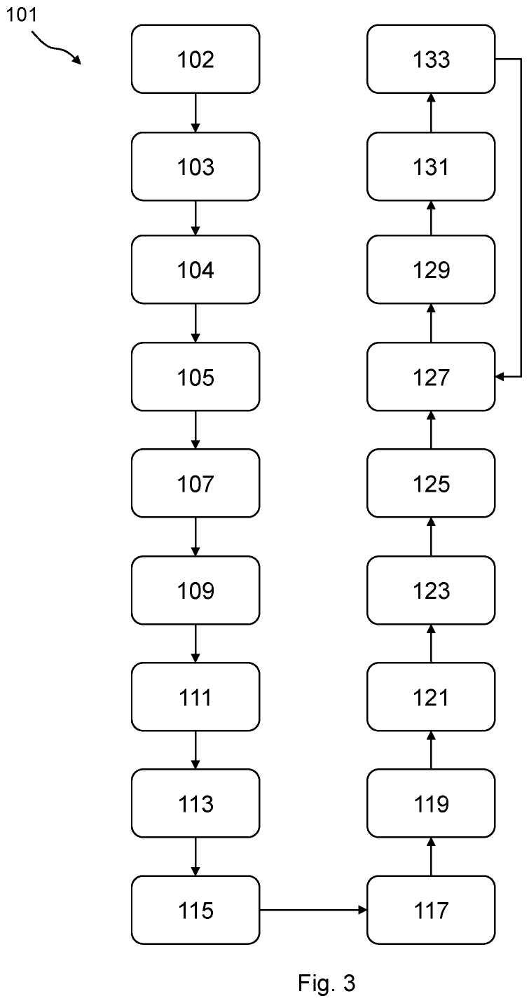

FIG. 3: a method according to the second aspect of the present disclosure is shown.

FIG. 1 displays the distortion of a fluid surface 9 by means of an air puff. This deformation of the fluid surface 9 will be monitored over time by a 2D surface laser sensor 27. With one known fluid 3, a pressure sensor before the air nozzle 21 and a fixed nozzle to surface distance, the pressure on the surface can be calculated. With this known pressure, all kinds of fluids can be analysed by means of a fitting procedure.

The fitting procedure that works together with numerical simulations of the fluid 3 are the key components that make the translation from the actual experiment to the material properties. With a known pressure on the top of the fluid surface 9 the experimental profile deformation 13 of the fluid 3 can be fitted with numerical simulations. By tuning this fitting procedure material parameters such as viscosity, surface tension, yield stress and viscoelastic properties of the fluid 3 can be obtained.

One exemplary simulation used for extracting the actual rheological and interfacial properties is described in reference to FIG. 1A, which shows a simulation domain of an embodiment of the present disclosure. The momentum balance and incompressible mass balance in the simulation domain are given by:

$$ρ \frac{Du}{Dt} = - ∇ p + ∇ \cdot τ + ρ g \\ ∇ \cdot u = 0$$

### Where

$$\frac{Du}{Dt}$$

is the material derivative, ρ is the density, U is the velocity of the fluid, P is the pressure, t is the time, τ is the extra stress tensor and g represents the body accelerations, such as, gravity and inertial accelerations. To simulate different kinds of fluids (Newtonian, viscoelastic, yield stress fluid etc.), different constitutive models can be chosen, which will change the way the extra stress tensor will be calculated. For a Newtonian fluid this extra stress tensor can be described by:

$$τ = η ( ∇ u + ∇ {u}^{T} ) .$$

The effect of the surface tension and the air pressure is implemented on the top of the fluid by the boundary condition:

$$σ \cdot n - P ( r ) \cdot n = σ ( {∇}_{s} \cdot n ) n .$$

Where the term on the right represents the normal stress due to the curvature of the interface and P(r) represents the air puff pressure applied to the top of the fluid. In the simulation, the position of the interface is updated in time using the velocity of the fluid.

In FIG. 1, a pressure unit 5 provides pressurized gas 7 with a nozzle 21 having a nozzle opening 23 to the surface 9 of the fluid 3. The pressure unit 5 further comprises a positioning unit 25 for positioning the nozzle opening 23 at a desired and predetermined distance from the surface 9 of the fluid 3. In an alternative embodiment it is conceivable that the nozzle opening 23 is maintained at a fixed position and a holder holding the fluid is moved for positioning the nozzle opening at the predetermined distance from the surface of the fluid. The surface deformation 13 of the fluid's surface 9, shown on the right of FIG. 1 as a close-up, is detected by a detection unit 11 that comprises the laser sensor 27.

FIG. 2 displays an apparatus 1 according to the first aspect of the present disclosure for measuring a rheological property such as viscosity, and/or an interfacial property such as surface tension, of a fluid 3 such as a liquid, suspension, gel or slurry. The apparatus 1 comprises a pressure unit 5, a detection unit 11, a pressure controller 29, a conditioning arrangement 10 and a main controller 33.

The pressure unit 5 and detection unit 11 are positioned above a container 8 such as a plate 8, that holds the sample fluid 3 to be analysed. The pressure of the gas 7 that is provided by the pressure unit 5 can be controlled with the pressure controller 29 and the position of the plate holding the fluid 3 relative to the pressure unit 5 and/or detection unit 11 can be controlled using motion controllers 31.

The pressure unit 5 is arranged for providing 103 a quantity of a gas 7 such as air, at a predetermined flow rate and a predetermined pressure to the surface 9 of the fluid 3 and is further arranged for varying the predetermined pressure in an oscillatory manner.

The detection unit 11 is arranged for detecting 105 a surface deformation 13 of the fluid 3, due to the pressurized gas 7 at a plurality of locations at the surface 9 of the fluid 3 for detecting a surface profile of the fluid 3, and is further arranged for detecting a time dependent surface deformation, due to the pressurized gas 7.

The conditioning arrangement 10 is arranged for conditioning a temperature of the container 8 and comprises a heating arrangement 12 for heating the container 8 and a cooling arrangement 14 for cooling the container 8. The apparatus 1 further comprises a temperature controller 16 arranged for controlling the conditioning arrangement 10 for heating and/or cooling the container 8 and for maintaining the temperature of the container 8 constant.

The conditioning arrangement 10 can be utilized for temperature control that can be used to control gelation for specific gels. With a change in temperature, the forming of a gel can be triggered and reversed. This can be useful for studying gels and their yield stress. The conditioning arrangement 10 can also be utilized for temperature control useful in the study of material properties at specific conditions as some material parameters are temperature dependent e.g. viscosity.

In such exemplary embodiments, a detection unit 11 can be arranged for detecting a surface deformation of the fluid, due to the pressurized gas, while a temperature controller 16 controls the conditioning arrangement 10 for temperature conditioning and/or control of the fluid disposed in the container 8. A reference register 15 according to this exemplary embodiment may include reference data related to surface deformations of respective fluids, due to pressurized gas at the predetermined pressure and at a predetermined temperature. The reference data can be related to known rheological properties and/or interfacial properties of the respective fluids.

The whole setup is controlled by one python script. This script, runs from the main controller 33, performs the initial calibration of the pressure, levelling of the sample and the experiment itself. The experimental data is logged into a database. The main controller 33 also comprises a reference register 15 comprising reference data related to surface deformations of respective fluids, due to pressurized gas at the predetermined pressure, and related to known rheological and/or interfacial properties of the respective fluids.

The main controller 33 further comprises a determining unit 17 arranged for receiving 109 the detected surface deformation 13 from the detection unit 11, accessing 111 the reference data of the reference register 15, determining 113 respective correlations between the detected surface deformation 13, and the surface deformations of the respective fluids from the accessed reference data, and identifying 115 a fluid of the respective fluids of the reference data based on a maximum correlation among the determined respective correlations.

Furthermore, the main controller 33 comprises an output unit 19 arranged for outputting 117 the rheological and/or interfacial property respectively corresponding with the fluid 3 identified by the determining unit 17, and a processing unit 16 arranged for performing simulations of surface deformations of respective fluids having known rheological and/or interfacial properties.

The reference data of the reference register 15 comprises data related to the following:
surface deformations of respective fluids and maximum surface deformations of respective fluids, detected by the detection unit 11;
time dependent surface deformations of respective fluids;
known rheological and/or interfacial properties of the respective fluids, determined by the determining unit 17;
computer simulations of surface deformations of respective fluids having known rheological and/or interfacial properties; and
a viscosity of the fluid 3, a surface tension of the fluid 3, a yield stress of the fluid 3 and viscoelasticity properties of the fluid 3, wherein the apparatus 1 is arranged for measuring the viscosity of the fluid 3, the surface tension of the fluid 3, the yield stress of the fluid 3 and viscoelasticity properties of the fluid 3.

With the above mentioned reference data available in the reference register 15, the determining unit 17 of the apparatus 1 is arranged for executing the following steps:
determining 119 a maximum surface deformation over time of the time dependent surface deformation;
determining 121 respective correlations between the detected maximum surface deformation, and the maximum surface deformations of the respective fluids from the accessed reference data;
determining 123 a gradient of the time dependent surface deformation; and
determining 125 respective correlations between the gradient of the time dependent surface deformation, and the time dependent surface deformations of the respective fluids from the accessed reference data.

Furthermore, the determining unit 17 is arranged for executing the steps of:
determining 127 respective correlations between the detected surface deformation, and the surface deformations of the respective fluids from the accessed reference data;
determining 129 that respective correlations between the detected surface deformation, and the surface deformations of the respective fluids from the accessed reference data are below the predetermined threshold value;
instructing the processing unit 16 to perform 131 simulations of surface deformations of respective fluids having known rheological and/or interfacial properties for obtaining further reference data related to surface deformations of fluids having rheological and/or interfacial properties that differ from the rheological and/or interfacial properties of the respective fluids of the reference data; and
adding 133, by the reference register 15, the further reference data, received by the reference register 15 from the processing unit 16, to the reference data of the reference register 15.

The predetermined threshold value is related to the maximum allowed difference between the simulation (reference data) and the measured surface deformation. The difference between the measurement and the reference data should be as small as possible, whereas the correlation and the related threshold value should be as high as possible. While the lowest possible value of the differences is 0 and the highest correlation possible is 1 (for completely matching measurements with reference data), the predetermined threshold values used in exemplary embodiments of the present disclosure will vary depending on the experiment.

The steps of determining 127, determining 129, instructing the processing unit 16 for performing 131 simulations and adding 133 are repeatedly executed by the determining unit 17, until a correlation of the respective correlations reaches or exceeds the predetermined threshold value.

FIG. 3 displays a flow diagram of a method 101 according to the second aspect of the present disclosure. The method 101 for measuring the rheological property such as viscosity and/or an interfacial property such as surface tension of the fluid 3, using the apparatus as described above, comprises the steps of:
providing 102 the fluid 3 in the container 8;
providing 103, by the pressure unit 5, a quantity of the gas 7 at a predetermined pressure to the surface 9 of the fluid 3, wherein the gas 7 is provided at a predetermined flow rate and wherein the predetermined pressure is controlled/varied depending on the executed test.
conditioning 104, by the conditioning arrangement 10, a temperature of the container 8, wherein the temperature controller 16 is controlling the conditioning arrangement 10 for heating and/or cooling the fluid 3 and wherein the temperature controller 16 is maintaining the temperature of the fluid 3 constant;
detecting 105, by a detection unit 11, the surface deformation 13 of the fluid 3, due to the pressurized gas 7 at a plurality of locations at the surface 9 of the fluid 3;
providing 107 the reference register 15 comprising reference data related to surface deformations of respective fluids and related to known rheological properties and/or interfacial properties of the respective fluid;
receiving 109, by the determining unit 17, the detected surface deformation 13 from the detection unit 11;
accessing 111, by the determining unit 17, the reference data of the reference register 15;
determining 113, by the determining unit 17, respective correlations between the detected surface deformation 13, and the surface deformations of the respective fluid from the accessed reference data;
identifying 115, by the determining unit 17, a fluid of the respective fluids of the reference data based on a maximum correlation among the determined respective correlations;
outputting 117, by the output unit 19, the rheological property and/or an interfacial property respectively corresponding with the fluid 3 identified by the determining unit 17;
determining 119, by the determining unit 17, a maximum surface deformation of a time dependent surface deformation;
determining 121, by the determining unit 17, respective correlations between the detected maximum surface deformation, and the maximum surface deformations of the respective fluids from the accessed reference data, wherein the reference data comprised by the reference register 15, is at least partly related to maximum surface deformations of respective fluids and related to known rheological properties and/or an interfacial properties of the respective fluids;
determining 123, by the determining unit 17, a gradient of the time dependent surface deformation; and
determining 125, by the determining unit 17, respective correlations between the gradient of the time dependent surface deformation, and the time dependent surface deformations of the respective fluids from the accessed reference data, wherein the reference data comprised by the reference register 15, is at least partly related to time dependent surface deformations of respective fluids and related to known rheological properties and/or interfacial properties of the respective fluids.

The method 101 further comprises the following steps:
determining 127, by the determining unit 17, respective correlations between the detected surface deformation, and the surface deformations of the respective fluids from the accessed reference data;
determining 129, by the determining unit 17, that respective correlations between the detected surface deformation, and the surface deformations of the respective fluids from the accessed reference data are below the predetermined threshold value;
performing 131, by the processing unit 16, simulations of surface deformations of respective fluids having known rheological properties and/or interfacial properties for obtaining further reference data related to surface deformations of fluids having rheological properties that differ from the rheological properties and/or interfacial properties of the respective fluids of the reference data; and
adding 133, by the reference register 15, the further reference data, received by the reference register 15 from the processing unit 16, to the reference data of the reference register 15;

Wherein the steps of determining 127, determining 129, performing 131 and adding 133 are repeated, until a correlation of the respective correlations

1. An apparatus arranged for measuring a rheological property such as viscosity and/or an interfacial property such as surface tension of a fluid such as a liquid, suspension, gel or slurry, the apparatus comprising:
a pressure unit arranged for providing a quantity of a gas, at a predetermined pressure to a surface of the fluid;
a detection unit arranged for detecting a surface deformation of the fluid, due to the pressurized gas at a plurality of locations at the surface of the fluid;
a reference register comprising reference data related to surface deformations of respective fluids, and related to known rheological and/or interfacial properties of the respective fluids;
a determining unit arranged for:
receiving the detected surface deformation from the detection unit;
accessing the reference data of the reference register;
determining respective correlations between the detected surface deformation, and the surface deformations of the respective fluids from the accessed reference data; and
identifying a fluid of the respective fluids of the reference data based on a maximum correlation among the determined respective correlations; and
an output unit arranged for outputting the rheological and/or interfacial property respectively corresponding with the fluid identified by the determining unit.

2. The apparatus according to claim 1, wherein the pressure unit is further arranged for providing the quantity of gas at a predetermined flow rate.

3. The apparatus according to claim 1, wherein the pressure unit comprises a nozzle for providing, via a nozzle opening thereof, the quantity of gas to the surface of the fluid, wherein the apparatus further comprises a positioning unit for positioning the nozzle opening relative to the surface of the fluid at a predetermined distance from the surface of the fluid.

4. The apparatus according to claim 3, wherein the nozzle opening defines a predetermined area of providing the quantity of gas to the surface of the fluid.

5. The apparatus according to claim 1, wherein the detection unit comprises a laser sensor.

6. The apparatus according to claim 1, wherein the reference data, comprised by the reference register, is at least partly related to surface deformations of respective fluids, detected by the detection unit, and related to rheological and/or interfacial properties of the respective fluids, determined by the determining unit.

7. The apparatus according to claim 1, wherein the reference data, comprised by the reference register, is at least partly related to computer simulations of surface deformations of respective fluids having known rheological and/or interfacial properties.

8. The apparatus according to claim 1, wherein the apparatus is arranged for measuring at least one of a viscosity of the fluid, a surface tension of the fluid, a yield stress of the fluid and viscoelasticity properties of the fluid, wherein the reference register comprises reference data related to at least one of a viscosity of the fluid, a surface tension of the fluid, a yield stress of the fluid and viscoelasticity properties of the fluid.

9. The apparatus according to claim 1, wherein the detection unit is further arranged for detecting a time dependent surface deformation, due to the pressurized gas.

10. (canceled)

11. (canceled)

12. The apparatus according to claim 1, wherein pressure unit is arranged for varying the predetermined pressure.

13. The apparatus according to claim 1, wherein the apparatus comprises a container, such as a plate, arranged for holding the fluid.

14. The apparatus according to claim 13, wherein apparatus is provided with a conditioning arrangement arranged for conditioning a temperature of the container.

15-17. (canceled)

18. The apparatus according to claim 1, wherein the apparatus further comprises:
a processing unit arranged for performing simulations of surface deformations of respective fluids having known rheological and/or interfacial properties.

19. The apparatus according to claim 18, wherein the determining unit is further arranged for:
determining that respective correlations between the detected surface deformation, and the surface deformations of the respective fluids from the accessed reference data are below a predetermined threshold value;
instructing the processing unit to perform simulations of surface deformations of respective fluids having known rheological and/or interfacial properties for obtaining further reference data related to surface deformations of fluids having rheological and/or interfacial properties that differ from the rheological and/or interfacial properties of the respective fluids of the reference data; and
adding, by the reference register, the further reference data to the reference data of the reference register.

20. The apparatus according to claim 19, wherein the determining unit is arranged for repeating the steps of:
determining respective correlations between the detected surface deformation, and the surface deformations of the respective fluids from the accessed reference data;
determining that respective correlations between the detected surface deformation, and the surface deformations of the respective fluids from the accessed reference data are below the predetermined threshold value;
instructing the processing unit to perform simulations of surface deformations of respective fluids having known rheological and/or interfacial properties for obtaining further reference data related to surface deformations of fluids having rheological and/or interfacial properties that differ from the rheological and/or interfacial properties of the respective fluids of the reference data; and
adding, by the reference register, the further reference data, received by the reference register from the processing unit, to the reference data of the reference register;
until a correlation of the respective correlations reaches or exceeds the predetermined threshold value.

21. A method for measuring a rheological property such as viscosity and/or an interfacial property such as surface tension of a fluid such as a liquid, suspension, gel or slurry, the method comprising the steps of:
providing, by a pressure unit, a quantity of a gas, at a predetermined pressure to a surface of the fluid;
detecting, by a detection unit, a surface deformation of the fluid, due to the pressurized gas at a plurality of locations at the surface of the fluid;
providing, a reference register comprising reference data related to surface deformations of respective fluids, and related to known rheological and/or interfacial properties of the respective fluids;
receiving, by a determining unit, the detected surface deformation from the detection unit;
accessing, by the determining unit, the reference data of the reference register;
determining, by the determining unit, respective correlations between the detected surface deformation, and the surface deformations of the respective fluids from the accessed reference data;
identifying, by the determining unit, a fluid of the respective fluids of the reference data based on a maximum correlation among the determined respective correlations; and
outputting, by an output unit, the rheological and/or interfacial property respectively corresponding with the fluid identified by the determining unit.

22. The method according to claim 21, wherein, during the step of providing the quantity of gas, the gas is provided at a predetermined flow rate.

23. The method according to claim 21, wherein the reference data, comprised by the reference register, is at least partly related to maximum surface deformations of respective fluids and related to known rheological and/or interfacial properties of the respective fluids and wherein the method further comprises the steps of:
determining, by the determining unit, a maximum surface deformation of a time dependent surface deformation; and
determining, by the determining unit, respective correlations between the detected maximum surface deformation, and the maximum surface deformations of the respective fluids from the accessed reference data.

24. The method according to claim 21, wherein the reference data, comprised by the reference register, is at least partly related to time dependent surface deformations of respective fluids and related to known rheological and/or interfacial properties of the respective fluids and wherein the method further comprises the steps of:
determining, by the determining unit, a gradient of the time dependent surface deformation; and
determining, by the determining unit, respective correlations between the gradient of the time dependent surface deformation, and the time dependent surface deformations of the respective fluids from the accessed reference data.

25-30. (canceled)

31. The method according to claim 21, wherein the method further comprises the steps of:
determining, by the determining unit, that respective correlations between the detected surface deformation, and the surface deformations of the respective fluids from the accessed reference data are below a predetermined threshold value;
performing, by the processing unit, simulations of surface deformations of respective fluids having known rheological and/or interfacial properties for obtaining further reference data related to surface deformations of fluids having rheological and/or interfacial properties that differ from the rheological and/or interfacial properties of the respective fluids of the reference data; and
adding, by the reference register, the further reference data to the reference data of the reference register.

32. (canceled)
